(19) United States
(12) Patent Application Publication
(10) Pub. No.: US 2025/0164788 A1
(43) Pub. Date: May 22, 2025

(54) REFLECTION MITIGATION FOR INACTIVE FACETS OF A REFLECTIVE WAVEGUIDE WITH NON-SELECTIVE COATING DEPOSITION

(71) Applicant: GOOGLE LLC, Mountain View, CA (US)

(72) Inventors: Alexander Koshelev, San Jose, CA (US); Christophe Peroz, Zurich (CH)

(21) Appl. No.: 18/516,142

(22) Filed: Nov. 21, 2023

(51) Int. Cl. G02B 27/01; G02B 6/34

(52) U.S. Cl. CPC G02B 27/0172; G02B 6/34; G02B 2027/0118; G02B 2027/0178

(57) ABSTRACT

A reflective waveguide includes active and inactive facets that are non-selectively coated with a partially reflective coating while minimizing reflections from the inactive facets without using a stencil mask. The partially reflective coating has a refractive index that is closely matched to a refractive index of a polymer substrate of the waveguide, is applied using a directional deposition technique such that the coating is thicker on the active prism facets than on the inactive prism facets, and the backside of the prism facets is angled such that the angle of incidence of display light on the backside of the prism facets is less than approximately 80 degrees.

### BACKGROUND

The present disclosure relates generally to augmented reality (AR) eyewear, which fuses a view of the real world with a heads-up display overlay. Eyewear display devices are wearable electronic devices that combine real world and virtual images via one or more optical combiners, such as one or more integrated combiner lenses, to provide a virtual display that is viewable by a user when the wearable display device is worn on the head of the user. One class of optical combiner uses a waveguide (also termed a lightguide) to transfer light. In general, light from a projector of the eyewear display device enters the waveguide of the optical combiner through an incoupler, propagates along the waveguide, and exits the waveguide through an outcoupler. The waveguide can also include an exit pupil expander positioned between the incoupler and the outcoupler to increase the size of the exit pupil within which the user can view the virtual image. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

In some cases, one or more of the incoupler, exit pupil expander, and the outcoupler are implemented in the waveguide as a set of reflective facets. Reflective waveguides employ semi-transparent reflective facets that function as louver mirrors to outcouple display light while enabling high efficiency, uniform augmented reality display with limited artifacts (low eye glow, low rainbow, etc.). Current polymer reflective waveguide fabrication processes use injection compression molding, ultraviolet, thermal, or hybrid casting, or other techniques to fabricate separate prism arrays using thermoplastic material. A reflector (such as a partially reflective coating) is coated on one of the prism arrays to form the reflective facets, and the separate prism arrays are bonded together to form the reflective waveguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing a reflective waveguide with prism facets that are coated to minimize reflections from inactive facets in accordance with some embodiments.

FIG. 2 is a diagram illustrating a cross-section view of an example implementation of a waveguide in accordance with some embodiments.

FIG. 3 is a side view of a grating structure having an index-matched partially reflective coating that is thicker on active facets of the grating structure in accordance with some embodiments.

FIG. 4 is a side view of directional deposition of a partially reflective coating on a grating structure in accordance with some embodiments.

FIG. 5 is a graph illustrating the reflectance of the multi-layer dielectric coating on active facets of a grating structure in accordance with some embodiments.

FIG. 6 is a graph illustrating reflectance of the multi-layer dielectric coating on inactive facets of a grating structure in accordance with some embodiments.

FIG. 7 is a side view of display light being guided through a reflective waveguide in accordance with some embodiments.

FIG. 8 is an illustration of a variable angle of inactive facets of a reflective prism structure of a reflective waveguide in accordance with some embodiments.

### DETAILED DESCRIPTION

A reflective facet waveguide of an eyewear display device includes one or more sets of reflective facets to implement one or more of the incoupler, outcoupler, or exit pupil expander. Utilizing an outcoupler as an example, the outcoupler is realized as a set of reflective facets that receives light from the exit pupil expander and reflects the light out of the waveguide to the user. Typically, the set of reflective facets is made by applying a reflective coating to active facets of an array of prisms (i.e., the front sides of each of the prisms) on a molded plastic or polymer substrate. Ideally, an inactive facet (i.e., backside) of each prism is left uncoated so that display light guided through the reflective waveguide is not reflected by the inactive facets, as reflection by the inactive facets can result in undesirable artifacts such as ghost images, light scattering toward the world side of the eyewear display system, and loss of light. However, due to molding process limitations, the backside angle of each prism is greater than zero (i.e., not perpendicular to the substrate). For example, in many implementations, the backside angle of each prism is between 5 to 15° to facilitate demolding. Because of the limitation on the backside angle of the prisms, preventing the reflective coating from coating the inactive facets of the prisms while the active prism facets are being coated is challenging.

One method of minimizing reflections from the inactive facets of the prisms of reflective waveguides is selective coating, in which the coating is applied only to the active prism facets. Stencil masks are typically used to shield the inactive prism facets from being coated when the coating is applied to the active prism facets. However, the stencil mask must be precisely aligned with the prism array, increasing the complexity of the fabrication process. In addition, the use of stencil masks increases the potential for shadow transition regions between the shielded and unshielded portions of the prism array in which the amount of coating deposited on the unshielded portions gradually tapers in the shielded portions rather than sharply transitioning between coated and uncoated areas. Such transition regions contribute to light scattering, reducing the display efficiency, and can also make the mirrors visible to outside observers.

An additional issue that occurs with reflective waveguides is a “louver effect” in which the inactive facets are transparent to the user but the active facets reflect approximately 10-15% of light, thus transmitting only approximately 85-90% of light from the environment. Further, the see-through transmission of environmental light varies with the viewing angle of the user.

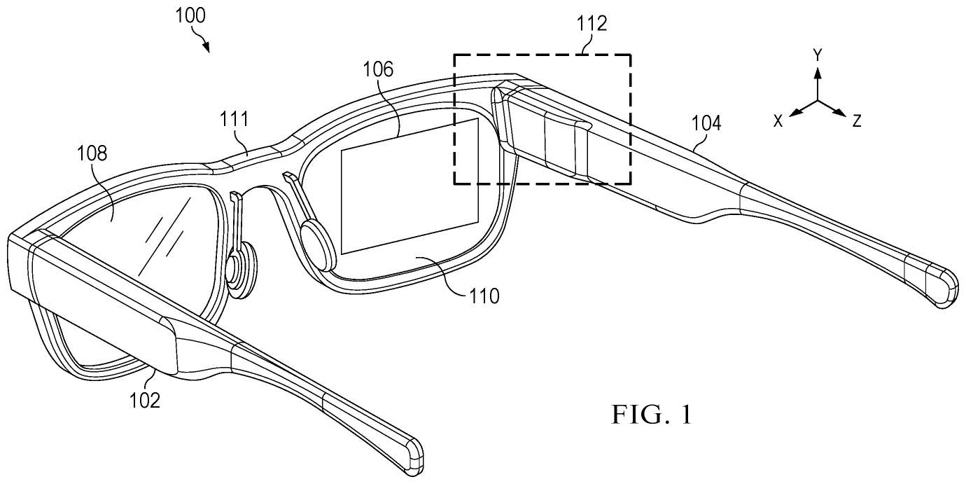

FIGS. 1-8 illustrate techniques for non-selectively coating an array of active and inactive facets (i.e., a prism array) of a reflective waveguide with a partially reflective coating while minimizing reflections from the inactive facets without using a stencil mask. The partially reflective coating has an effective refractive index that is closely matched to the refractive index of the waveguide substrate, is applied using a directional deposition technique such that the coating is thicker on the active prism facets than on the inactive prism facets, and the backside of the prism facets is angled such that the angle of incidence of display light on the backside of the prism facets is less than approximately 80°. In some embodiments, the partially reflective coating is a multi-layer dielectric coating having an average refractive index that differs from the refractive index of the waveguide substrate by less than approximately 0.1, and in some embodiments by less than approximately 0.03.

The partially reflective coating is applied using a directional deposition technique such as evaporation or sputtering such that the coating layers on the inactive prism facets are thinner than the coating layers on the active prism facets. For example, in some embodiments the thickness of the coating layers on the backsides of the prisms is less than approximately 70% of the thickness of the coating layers on the front sides of the prisms. In some embodiments, the thickness of the coating layers on the backsides of the prisms is less than approximately 20-50% of the thickness of the coating layers on the front sides of the prisms. To achieve the differential in coating thicknesses, in some embodiments the substrate is tilted while the partially reflective coating is applied.

In some embodiments, no single layer of the multi-layer coating on the active prism facets is thicker than 200 nm (or 100 nm in some cases) to ensure that each layer of the multi-layer coating is thinner than the wavelengths of light that are guided through the reflective waveguide. For example, layers that are on the order of a quarter of a wavelength can be combined with thinner layers and result in a structure that acts as an interference coating to reflect light from the active prism facets. By maintaining the thickness of each layer of the multi-layer coating within the range of approximately 10 nm-200 nm on the active prism facets and using the directional deposition technique such that each layer of the multi-layer coating on the inactive prism facets is thinner (e.g., at least approximately 50% thinner) than the same layer on the active prism facets (e.g., less than a quarter of a wavelength), the multi-layer coating on the inactive prism facets acts as a meta material (i.e., an apparent single-layer coating) that has a refractive index that is the average of the refractive indices of the component layers. By matching the average refractive index of the multi-layer coating to the refractive index of the polymer substrate and applying a thinner coating to the inactive prism facets than to the active prism facets, the reflectance for most angles of incidence of display light on the inactive prism facets approaches zero.

To further minimize reflectance of display light from the inactive prism facets, the backside angle of the prism is selected to be less than approximately 20°, such that display light traveling through the reflective waveguide via total internal reflection has an angle of incidence against the backside of the prism that is below approximately 80°. Under such conditions, reflectance from the backside of the prism is minimized, and in some cases does not exceed 1%.

To mitigate the “louver effect” of inactive facets being fully transparent and active facets being partially reflective for environmental light, dependent on the viewing angle of the user, in some embodiments, the angle of the inactive facets with respect to the normal of the substrate is selected such that the transmission of environmental light through both the active and inactive facets is the same from the perspective of the user. Because different portions of the outcoupler of the waveguide are viewed at different angles, the angle of each inactive facet varies with the angular distance from a pupil of a user's eye in some embodiments. Thus, the different inactive facets are viewed at the same angle of incidence from the point of view of the user.

FIG. 1 illustrates an example AR eyewear display system 100 implementing a reflective waveguide formed by non-selectively coating a prism array on a substrate with a partially reflective coating having a refractive index that closely matches the refractive index of the substrate and is thicker on active prism facets than on inactive prism facets, and in which the backside angles of the prisms is selected such that display light has an angle of incidence on the inactive prism facets less than approximately 80° in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes an eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

To allow for a smaller, more compact form-factor, in some embodiments, one or more of the IC, OC, and/or EPE use reflective waveguide facets either to reflect light from one surface of the waveguide back to the same surface or to allow light to travel through the facets from one surface of the waveguide to a different, opposing surface of the waveguide. The facets are faces of prisms arrayed on a substrate. Each prism includes an active facet which reflects display light that is guided through the waveguide and an inactive facet from which reflections of display light are undesirable.

In order to minimize reflections from the inactive facets, the prisms are non-selectively coated with a partially reflective coating that is closely index-matched to the substrate. The coating is applied using a directional deposition technique such as evaporation or sputtering such that the coating on the inactive facets is thinner than the coating on the active facets. For example, in some embodiments, the coating is applied using a directional deposition technique at an angle, such as while the prisms and substrate are tilted. In addition, the backside angle of the prisms with respect to the normal of the substrate is less than approximately 20°, such that light propagating through the waveguide at TIR angles ranging from approximately 40° to 60° has an angle of incidence against the inactive facets that is below approximately 80°.

In some embodiments, the angle of the backsides of the prisms with respect to the normal of the substrate is selected such that the transmission of environmental light through both the active and inactive facets is the same from the perspective of the user. In addition, the angle of each prism backside varies with the angular distance from an eyebox of the waveguide in some embodiments such that the different prism backsides are viewed at the same angle of incidence from the point of view of the user.

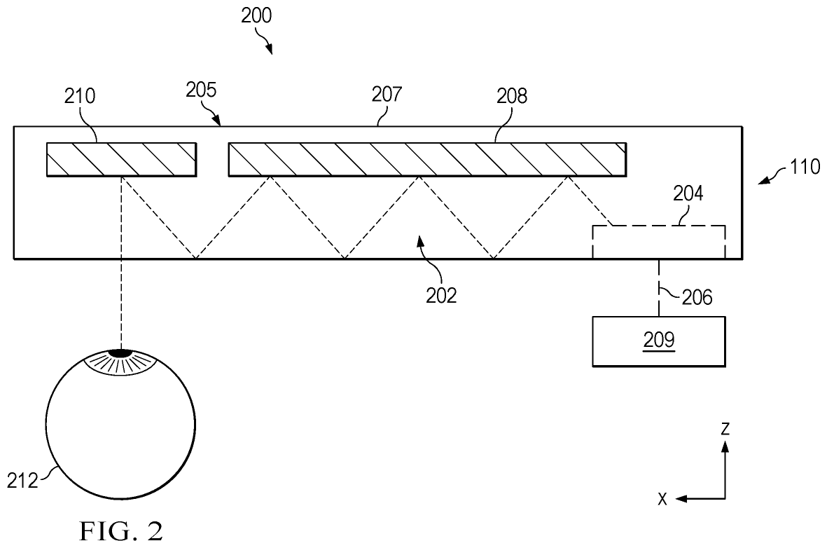

FIG. 2 depicts a cross-section view of an implementation of a display system 200 partially included in a lens element such as lens element 110 of an AR eyewear display system such as AR eyewear display system 100, which in some embodiments comprises a waveguide 202. Note that for purposes of illustration, at least some dimensions in the Z direction are exaggerated for improved visibility of the represented aspects.

The waveguide 202 includes an incoupler 204 and an outcoupler 210. The term “waveguide,” as used herein, will be understood to mean a combiner using one or more of total internal reflection (TIR), specialized filters, and/or reflective surfaces, to transfer light from an incoupler (such as the incoupler 204) to an outcoupler (such as the outcoupler 210). In some display applications, the light is a collimated image, and the waveguide transfers and replicates the collimated image to the eye. In general, an incoupler and outcoupler each include, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

In the present example, the display light 206 received at the incoupler 204 is relayed to the outcoupler 210 via the waveguide 202 using TIR. The display light 206 is then output to the eye 212 of a user via the outcoupler 210. As described above, in some embodiments the waveguide 202 is implemented as part of an eyeglass lens, such as the lens 108 or lens 110 (FIG. 1) of the display system having an eyeglass form factor and employing the display system 200.

In this example implementation, the waveguide 202 implements facets in the region 208 (which provide exit pupil expansion functionality) and facets of the region 210 (which provide OC functionality) toward the world-facing side 207 of the waveguide 202 and the lens element 110, and the facets of the IC 204 are implemented toward the eye-facing side 205 of the lens element 110. Thus, under this approach, display light 206 from a light source 209 is incoupled to the waveguide 202 via the IC 204, and propagated (through total internal reflection in this example) toward the region 208, whereupon the facets of the region 208 reflect the incident display light for exit pupil expansion purposes, and the resulting light is propagated to the facets of the region 210, which output the display light toward a user's eye 212. In other embodiments, the facets of the IC 204 are implemented toward the world-facing side 207 of the lens element 110.

Embodiments of reflective waveguide structures formed and non-selectively coated according to the techniques described herein achieve uniform display quality with limited artifacts using reflective waveguide facets. For example, in some embodiments, the facets allow display light to travel through the facets from one surface of the waveguide to a different, opposing surface of the waveguide rather than, e.g., reflecting the light from one surface back onto the same surface. In some embodiments, the facets are coated with an index-matched partially reflective coating that is thicker on active facets than on inactive facets that enables this functionality.

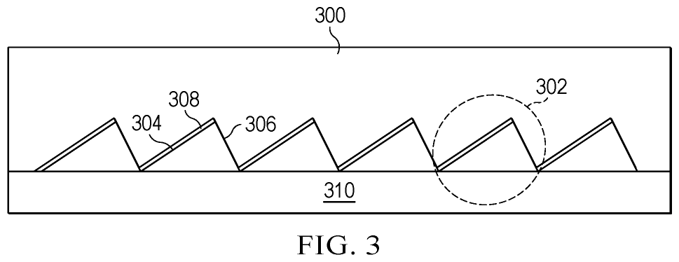

FIG. 3 is a side view of a waveguide grating structure 300 having an index-matched partially reflective coating that is thicker on active facets of the grating structure in accordance with some embodiments. The grating structure 300 includes a substrate 310 on which a series of prisms 302 are formed through, e.g., compression injection molding. In some embodiments, the substrate is a polymer having a refractive index. Each prism 302 includes an active facet 304 and an inactive facet 306. The active facets 304 are coated with a partially reflective coating 308 such as a multi-layer dielectric coating to form a series of semi-transparent louver mirrors which collectively make up a segmented mirror.

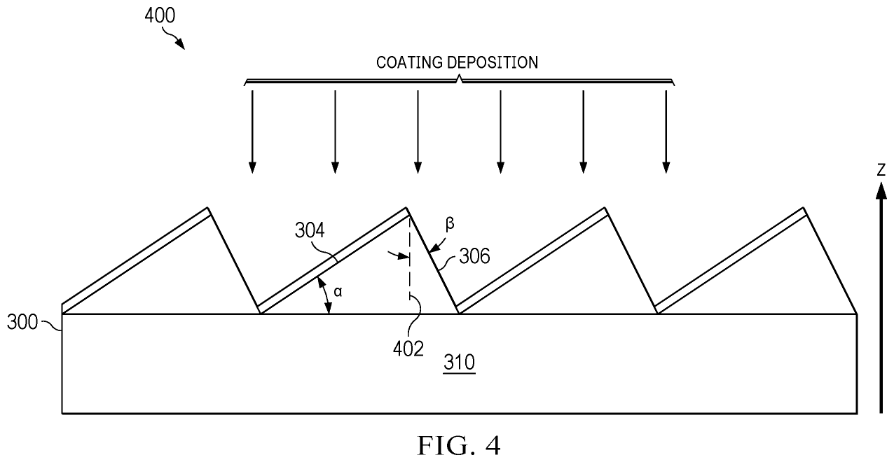

To reduce reflections from the inactive facets 306 without the use of a stencil mask, a directional deposition technique such as illustrated in FIG. 4 is employed to apply a thicker coating 308 to the active facets 304 than to the inactive facets 306. FIG. 4 is a side view 400 of directional deposition of a partially reflective coating on a grating structure in accordance with some embodiments. The active facets 304 are formed at an angle α with respect to the plane of the substrate 310 and the inactive facets 306 are formed at an angle β with respect to the normal 402 of the substrate 310. The directional deposition of the coating results in a nominal coating thickness Tₜₒₜ on the active facets 304 and a maximum thickness of the same coating T_{back}=kTₜₒₜ on the inactive facets 306 where k≤70%. In some embodiments, k≤50%, and in still other embodiments, k≤30%. To aid in applying a thicker coating to the active facets 304 than the inactive facets 306, in some embodiments, the grating structure 300 is tilted during the directional deposition of the coating. For example, in some embodiments the grating structure 300 illustrated in FIG. 4 is tilted such that the left end of the grating structure 300 is higher than the right end of the grating structure 300 so that more coating is deposited on the active facets 304 and less coating is deposited on the inactive facets 306.

In some embodiments, the partially reflective coating is a multi-layer dielectric coating for which the average refractive index of the layers of the coating n_{coat} approximately matches the refractive index n_{poly} of the polymer substrate 310. For example, in some embodiments, Δn=|n_{coat}−n_{poly}|≤0.1. In other embodiments, Δn=|n_{coat}−n_{poly}|≤0.02. Further, each layer of the multi-layer dielectric coating that is deposited on the active facets 304 is less than approximately 200 nm thick, or less than 100 nm thick in some embodiments, such that the layers of the inactive facets 306, which are less than 50-70% as thick as the layers of the active facets 304, are sufficiently thin to act as a metamaterial (i.e., a single layer with the average refractive index).

An example of the layers of a multi-layer dielectric coating and their respective refractive indices and thicknesses on the active facets 304 of a waveguide structure 300 is provided in Table 1 below.

TABLE 1

| | | Refractive | |
|---|---|---|---|
| Layer # | Material | index at 587 nm | Thickness, nm |
| | Substrate polymer | 1.6 | |
| 1 | SiO2 | 1.458 | 49.04 |
| 2 | HfO2 | 1.921 | 22.82 |
| 3 | Al2O3 | 1.661 | 128.97 |
| 4 | SiO2 | 1.458 | 64.78 |
| 5 | HfO2 | 1.921 | 24.63 |
| 6 | SiO2 | 1.458 | 15.65 |
| 7 | HfO2 | 1.921 | 40.65 |
| 8 | SiO2 | 1.458 | 95.95 |
| 9 | HfO2 | 1.921 | 24.71 |
| 10 | Al2O3 | 1.661 | 79.06 |
| 11 | HfO2 | 1.921 | 11.24 |
| 12 | SiO2 | 1.458 | 40.85 |
| 13 | Al2O3 | 1.661 | 89.17 |
| 14 | SiO2 | 1.458 | 18.54 |
| 15 | Al2O3 | 1.661 | 124.28 |
| 16 | SiO2 | 1.458 | 27.64 |

In the example of Table 1, the average index of the multi-layer dielectric coating is 1.625 at 587 nm, which approximately matches the refractive index n=1.6 of the polymer substrate (Δn<0.02). Further, the thickest layer in the multi-layer dielectric coating is layer 3, which is 128.97 nm thick (i.e., less than 200 nm).

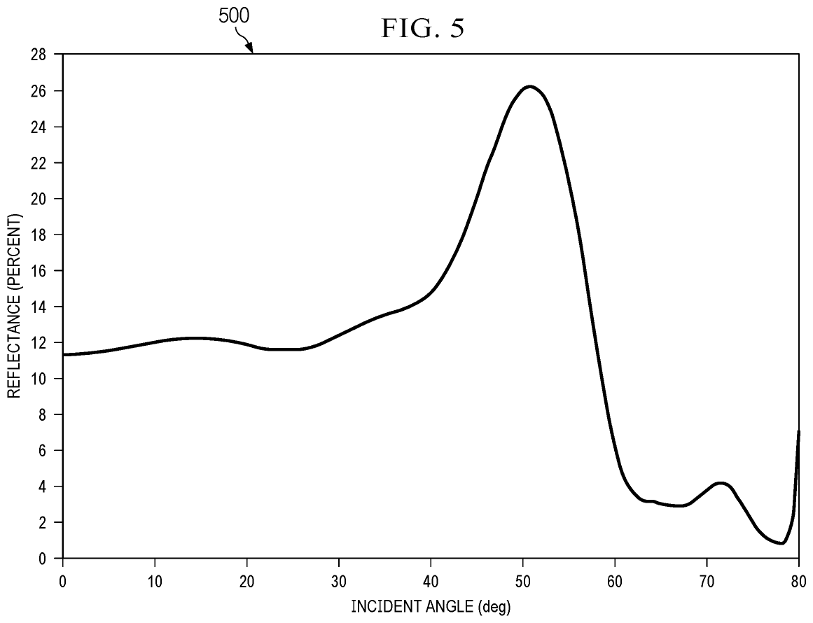

FIG. 5 is a graph 500 illustrating the reflectance of the multi-layer dielectric coating on the active facets 304 as a function of the angle of incidence at 460 nm, average polarization. The coating in the illustrated example targets approximately 12% reflectance for the angles of incidence (approximately) 15°-30° on the active facets 304.

Due to the directional deposition of the coating (in some embodiments further facilitated by tilting the grating structure 300 during application of the multi-layer dielectric coating), each layer of the coating deposited on the inactive facets 306 is up to approximately 70% thinner than each layer of the coating deposited on the active facets 304. As such, the layers are substantially subwavelength (e.g., less than a quarter of a wavelength thick) for light propagating through the waveguide at angles that are not close to a 90° angle of incidence. In effect, the multi-layer dielectric coating on the inactive facets 306 acts as a metamaterial with an index of refraction equal to the average index of refraction of the coating layers. As with the coating on the active facets 304, the coating on the inactive facets 306 has an average index of refraction that is closely matched to the refractive index of the polymer substrate 310. Because the average index of refraction of the multi-layer dielectric coating closely matches the refractive index of the polymer substrate 310 and the multi-layer dielectric coating acts as a metamaterial on the inactive facets 306, the reflectance for most angles of incidence on the inactive facets 306 approaches zero.

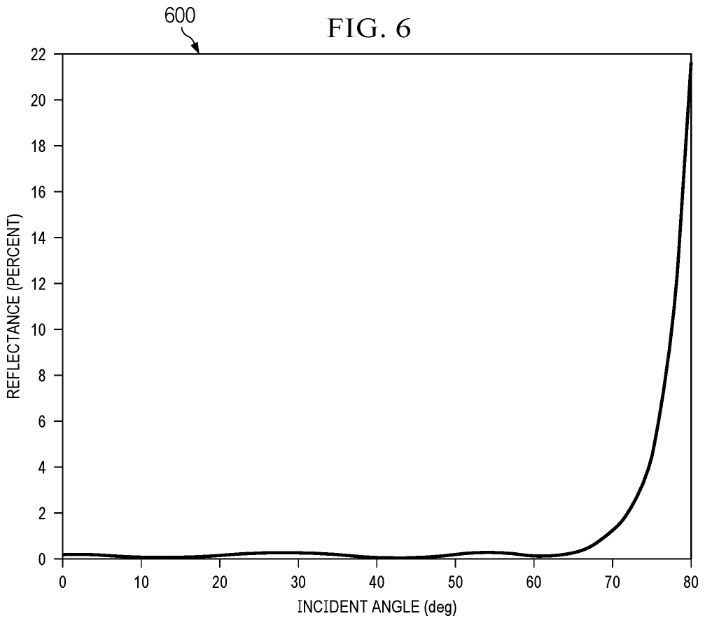

FIG. 6 is a graph 600 illustrating reflectance of the multi-layer dielectric coating on the inactive facets 306 as a function of the angle of incidence at 460 nm, average polarization, with the thicknesses of the layers listed in Table 1 scaled to 50% to simulate the thickness of the multi-layer dielectric coating on the inactive facets 306. For angles of incidence less than approximately 70°, the reflectance of the inactive facets 306 is well under 1% for light having a wavelength of 460 nm, which corresponds to the approximate wavelength of blue display light. Because of their longer wavelengths, the reflectance of the inactive facets 306 for green and red display light is even lower. The low reflectance of the inactive facets 306 when thinly coated with a multi-layer dielectric coating having an average refractive index that closely matches the refractive index of the polymer substrate 310 as described herein limits world-side leakage of display light, image ghosts, and loss of light.

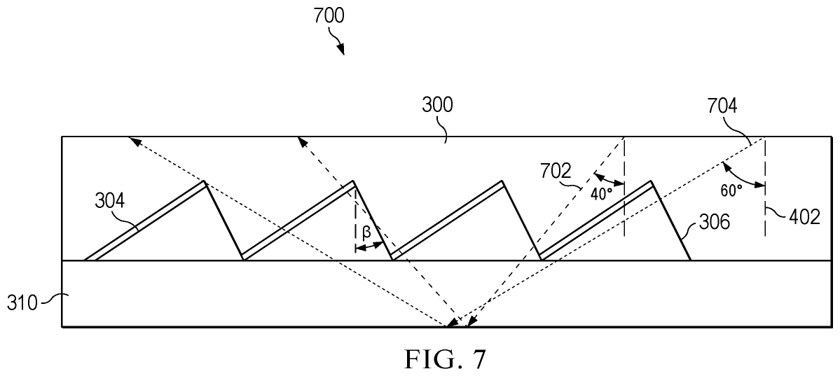

FIG. 7 is a side view 700 of display light being guided through a reflective waveguide in accordance with some embodiments. To further minimize reflections from the inactive facets 306 of the waveguide grating structure 300, the angle β of the backside of the prism with respect to the normal 402 of the substrate 310 is selected such that the angle of incidence on the inactive facets 306 for any display light traveling through the waveguide via total internal reflection is less than approximately 70°.

Accordingly, for display light propagating through a waveguide incorporating the waveguide grating structure 300 at TIR angles from 40° (illustrated by solid line 702) to 60° (illustrated by dashed line 704) with respect to the normal 402 of the substrate 310, the angle of incidence of the display light on the inactive facets 306 is between 30°-β and 50°-β for light traveling down as illustrated in FIG. 7 and between 30°+β and 50°+β for light traveling up. In some embodiments, β is selected to be below approximately 20° to ensure that the angle of incidence of display light traveling through the waveguide at TIR angles of 40° to 60° will remain below approximately 70°. Under such conditions, the reflectance from the inactive facets 306 does not exceed approximately 1%.

As discussed above, an eyewear display device implementing a reflective waveguide includes lens elements such as lens elements 108, 110 that are sufficiently transparent to allow a user to see through the lens elements to provide a field of view of the user's real-world environment such that an image formed by display light propagating through the waveguide appears superimposed over at least a portion of the real-world environment. Whereas the inactive facets 306 are transparent to the user for see-through transmission of light from the environment (whether because selective coating or the non-selective coating methods described herein were used), the active facets 304 reflect approximately 10-15% of incident light from the environment, thus only transmitting 85-90% of incident environmental light, resulting in a louver effect in which the see-through transmission of environmental light depends on the user's viewing angle.

To mitigate the louver effect for environmental light transmitted through the waveguide, in some embodiments the angle β of the backside of the prisms 302 is selected such that the transmission of environmental light through the active facets 304 and the inactive facets 306 is the same from the user's perspective. For a reflective waveguide with inactive facets 306 having a reflectance similar to that shown in FIG. 6, if the inactive facets 306 are viewed from the user's perspective at approximately 78°, the user will see approximately 12% reflectance of environmental light from the inactive facets 306, which is approximately the same as the reflectance the user will see from the active facets 304. Thus, in some embodiments, the angle β of the backside of the prism with respect to the normal 402 of the substrate 310 is selected to be 12°, such that the inactive facet 306 directly in front of the user's pupil is viewed at approximately 78° from the user's point of view.

However, different portions of the waveguide grating structure 300 are viewed by the user from different angles. To provide an approximately uniform viewing angle of incidence of the inactive facets 306 from the point of view of the user, the angles β for each inactive facet is varied. In other words, each inactive facet 306 in a series of facets has a slightly different angle β of the backside of the prism with respect to the normal 402 of the substrate 310 in some embodiments.

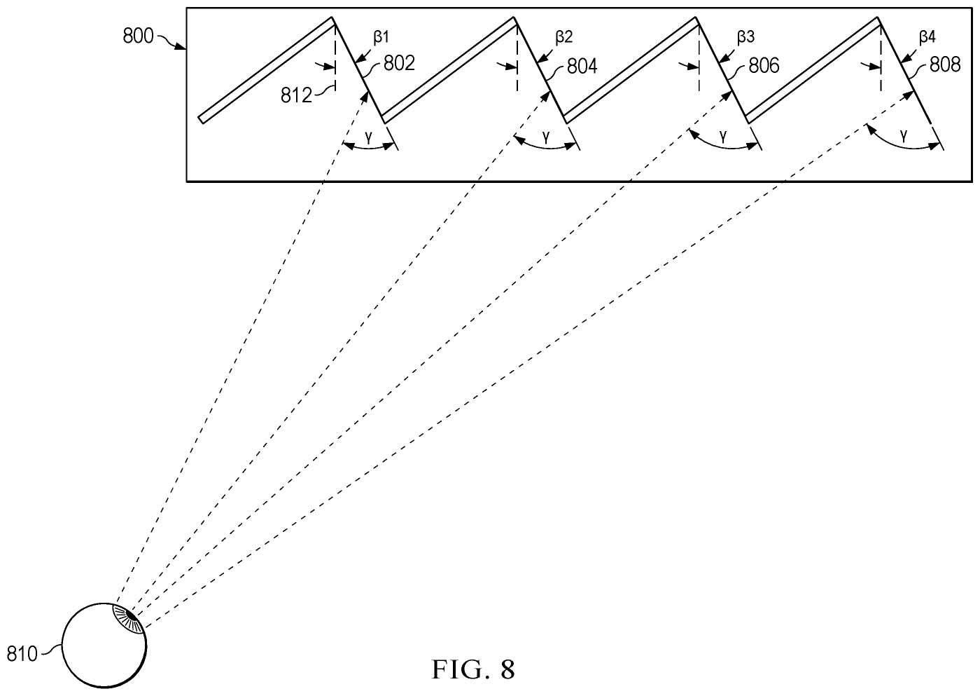

FIG. 8 is an illustration of a variable angle of inactive facets 802, 804, 806, 808 of a reflective prism structure 800 of a reflective waveguide in accordance with some embodiments. Each inactive facet 802, 804, 806, 808 has a different angle with respect to the normal 812 of the substrate. Thus, in the illustrated example, inactive facet 802 has an angle β1, inactive facet 804 has an angle β2, inactive facet 806 has an angle β3, and inactive facet 808 has an angle β4 with respect to the normal 812 of the substrate.

The angles β1, β2, β3, and β4 are selected based on angular distance to a pupil 810 of an eye of a user such that an angle of incidence y for light traveling through the inactive facets 802, 804, 806, 808 to the pupil 810 of the eye of a user is approximately the same for each of the inactive facets 802, 804, 806, 808. In the illustrated example, the angle for each successive adjacent inactive prism facet in the reflective prism structure 800 is greater relative to the normal of the substrate than the angle of the previous inactive prism facet as the angular distance to the pupil decreases. Thus, β1<β2<β3<β4 in the illustrated example.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A reflective waveguide, comprising:
a grating structure on a substrate comprising active facets and inactive facets non-selectively coated with a partially reflective coating, wherein
a first thickness of the partially reflective coating on the active facets is thicker than a second thickness of the partially reflective coating on the inactive facets;
the first refractive index approximately matches a refractive index of the substrate; and
an angle of incidence of display light guided through the reflective waveguide via total internal reflection on the inactive facets is less than approximately 80 degrees.

2. The reflective waveguide of claim 1, wherein the first refractive index and the refractive index of the substrate differ by less than approximately 0.1.

3. The reflective waveguide of claim 1, wherein the second thickness is less than approximately 70% of the first thickness.

4. The reflective waveguide of claim 1, wherein the partially reflective coating comprises a plurality of layers and wherein the first refractive index is an average refractive index of the plurality of layers.

5. The reflective waveguide of claim 4, wherein each layer of the plurality of layers is less than approximately 200 nm thick.

6. The reflective waveguide of claim 1, wherein an angle of each inactive facet relative to a normal of the substrate varies based on angular distance to a pupil of a user of an eyewear display device implementing the reflective waveguide.

7. The reflective waveguide of claim 6, wherein the angle for each successive inactive facet in the grating structure is greater relative to the normal of the substrate than the angle of an adjacent inactive facet as the angular distance to the pupil decreases.

8. A method comprising:
non-selectively applying a partially reflective coating having a first refractive index to a grating structure comprising active facets and inactive facets on a substrate of a waveguide, wherein:
a first thickness of the partially reflective coating on the active facets is thicker than a second thickness of the partially reflective coating on the inactive facets;
the first refractive index approximately matches a refractive index of the substrate; and
the inactive facets have an angle with respect to a normal of the substrate of less than approximately 20 degrees.

9. The method of claim 8, wherein the first refractive index and the refractive index of the substrate differ by less than approximately 0.1.

10. The method of claim 8, wherein non-selectively applying comprises directionally depositing the partially reflective coating on the grating structure and wherein the second thickness is less than 70% of the first thickness.

11. The method of claim 8, wherein the partially reflective coating comprises a plurality of layers and wherein the first refractive index is an average refractive index of the plurality of layers.

12. The method of claim 11, wherein each layer of the plurality of layers is less than 200 nm thick.

13. The method of claim 8, further comprising:
varying the angle of each inactive facet relative to a normal of the substrate based on angular distance to a pupil of a user of an eyewear display device implementing the waveguide.

14. The method of claim 13, wherein varying comprises:
setting the angle for each successive inactive facet in the grating structure to be greater relative to the normal of the substrate than the angle of an adjacent inactive facet as the angular distance to the pupil decreases.

15. A reflective waveguide, comprising:
a grating structure on a substrate, the grating structure comprising a series of active facets and inactive facets, wherein
the active facets are non-selectively coated with a partially reflective coating having a first thickness and a refractive index that approximately matches a refractive index of the substrate; and
the inactive facets are coated with the partially reflective coating having a second thickness thinner than the first thickness have an angle with respect to a normal of the substrate of less than approximately 20 degrees.

16. The reflective waveguide of claim 15, wherein the first refractive index and the refractive index of the substrate differ by less than approximately 0.1.

17. The reflective waveguide of claim 15, wherein the second thickness is less than approximately 70% of the first thickness.

18. The reflective waveguide of claim 15, wherein the partially reflective coating comprises a plurality of layers and wherein the first refractive index is an average refractive index of the plurality of layers.

19. The reflective waveguide of claim 18, wherein each layer of the plurality of layers is less than approximately 200 nm thick.

20. The reflective waveguide of claim 15, wherein the angle of each inactive facet relative to the normal of the substrate varies based on angular distance to a pupil of a user of an eyewear display device implementing the reflective waveguide.
